(19) United States
(12) Patent Application Publication
(10) Pub. No.: US 2002/0129056 A1
(43) Pub. Date: Sep. 12, 2002

(54) Method and apparatus for electronic negotiation of document content

(76) Inventors: Michael V. Conant, Los Altos, CA (US); Charles A. Grasso, San Carlos, CA (US); Thomas M. Raday, San Mateo, CA (US); George Roman, Los Altos, CA (US); Andrew T. Zeilman, Palo Alto, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/782,033

(22) Filed: Feb. 14, 2001

Related U.S. Application Data
(60) Provisional application No. 60/254,197, filed on Dec. 11, 2000.

(51) Int. Cl. G06F 15/00

(52) U.S. Cl. 707/511; 707/507

(57) ABSTRACT

A method and apparatus provide for the negotiation of the content of a document via an electronic exchange. In one example an electronic exchange operates as a repository of forms of contracts. A user can initiate a negotiation process by selecting a form contract and, if desired, customizing the contract to a particular transaction. The user can then advise a third party as to the existence of the contract on the exchange. The parties can then conduct a negotiation of contract terms on the exchange in accordance with permissions prescribed by the exchanged and/or the user.

### BACKGROUND

The present invention relates to a method and apparatus for establishing and storing content and semantics of a document. More particularly, the present invention relates to a method and apparatus by which a document, such as a contract, can be negotiated electronically.

The creation of any written document is normally a heavily iterative process. Typically a first draft of a document is prepared and that draft is then edited and edited again. Sometimes the document is edited many more times before the document is placed in its final form. Finalizing a document is significantly more complicated where multiple parties are responsible for the final content of the document. For instance, the document may have multiple authors, editors and/or approvers. Alternatively, the document may be a legal instrument whose contents need to be negotiated between parties. An example of such a legal instrument is a contract where two or more parties attempt to come to terms on a business transaction.

Any time a second party is introduced into the document creation process, problems arise. The most acute problem is making sure that when one party revises the document it is assured that it is revising the most up-to-date version of the document. This problem is particularly acute when the parties are at disparate locations. When the contents of the document need to be negotiated between the parties it is even more difficult to maintain an electronic document that accurately reflects the postures of the negotiating parties in a way that facilitates the continuation of negotiation.

When one considers the realm of business transactions and the creation and negotiation of contracts, one sees that the problem of document creation and control become particularly troublesome. At present, many institutions maintain one or more standard contracts which include therein one or more blank fields into which information must be entered so as to create a document to address a particular transaction. In the simplest form a draft standard contract is a template that has blank fields such as fields related to the party of the second part. Examples of such fields include locations for identifying the second party, the incorporation state of that party and the address of that party. In a more complex agreement certain of the business terms of the contract, such as quantity of product to be provided and price for the product, need to be inserted as well. Where an organization has different types of contracts to deal with different types of business transactions, that organization must maintain records of these various standard contracts or contract templates. Today a contract proposer will send either a hard copy or an electronic copy of a contract to a second party. Upon receipt, the second party can mark-up the contract and return the marked-up version to the contract proposer. The response may or may not include a redline version of the contract showing the changes to the original text proposed by the second party. Typically the negotiation process continues with further iterations of the draft contract. When final agreement is reached hard copies of the documents are executed or signed by principals associated with the respective parties thereby indicating agreement to the terms of the contract.

The present techniques for maintaining and facilitating content negotiation by multiple parties are limited in that they require intensive document exchange with little in the way of maintaining a repository of historical information about these document changes. In addition, little is provided in the way of document control to assure that parties are working on the appropriate versions of the documents. Furthermore a party having a significant library of standard contracts (and/or clauses which might be alternative choices for use in such contracts) has no convenient way for constructing a proposed contract and presenting it for revision to a second party with document control being supervised by a disinterested third party.

### SUMMARY OF THE INVENTION

A method and apparatus provide a capability for electronic negotiation of the content of a document. This electronic negotiation tool can be applied to business transaction documents such as contracts, requests for proposals, engineering design documents and other like documents. The tool permits the first party, having one or more individual users, to access a database of document content and construct a draft of the document. In one example the draft document constitutes a draft contract either selected from a library of contracts associated with the first party or created from a selection of standard clauses in a standard clause database associated with the first party. The second party, which may also include one or more individual users, receives a notification of the existence of and the location of the document and is provided with certain revision privileges. In one example the second party is permitted to negotiate the document on a clause-by-clause basis and in another configuration the second party is permitted to negotiate only on a contract-as-a-whole basis. As the second party proposes revisions to the contract those revisions are maintained and a history file is created in association with the contract. The first and the second party are provided with editing privileges in a manner that guarantees that a party has the most up-to-date revision of the document.

The negotiating tool of the present invention provides improved document control as well as facilitates a negotiation process involving the content of the document. In addition the tool creates a revision history which facilitates the interpretation of the document upon completion.

### BRIEF DESCRIPTION OF THE DRAWINGS

FIG. 1 presents a schematic representation of an environment in which the present invention may be employed.

FIG. 2 presents a block diagram representation of a contract exchange of FIG. 1 in accordance with an embodiment of the present invention.

FIGS. 3 to 5 are flow diagrams which together illustrate a negotiation method in accordance with an embodiment of the present invention.

FIG. 6 provides a flow diagram for creating content usable in the embodiment of FIG. 2, in accordance with an embodiment of the present invention.

FIG. 7 provides a flow diagram for a second embodiment for creating content to be used in the embodiment of FIG. 2.

FIG. 8 provides a flow diagram for a method for maintaining a revision history in connection with an electronic negotiation in accordance with an embodiment of the present invention.

FIGS. 9 to 18 illustrate sample user interface screens which can be employed in connection with an embodiment of the present invention.

### DETAILED DESCRIPTION

The present invention provides a method and an apparatus by which multiple parties can negotiate the content of a document. The types of documents include: contracts; requests for proposal; statements of work; letters of intent; articles; publications; computer programs and other works that involve multiple parties who author, edit or approve content. This is not meant to be an exhaustive list, merely a suggestion of the types of documents of interest. The negotiation process is carried out electronically with appropriate controls over document access to assure that a given party is working on the most up-to-date version of the document. In addition the access to the document is controlled so as to provide a secure and accurate history of the revision sequence with regard to the contents of the document. Furthermore, the method and apparatus provide a technique for assisting a party who enters into many different types of business transactions to create an easy to use repository, such as a data store or a database, for constructing draft contracts to be provided electronically to other entities for consideration.

Throughout the remainder of this application the embodiments of the invention will be described in relation to a contract or contracts. However, as should be clear from the description, the inventors are not limiting their invention to the realm of contracts. The invention may be applied to other documents, the contents of which are to be negotiated or agreed upon by multiple parties as identified above.

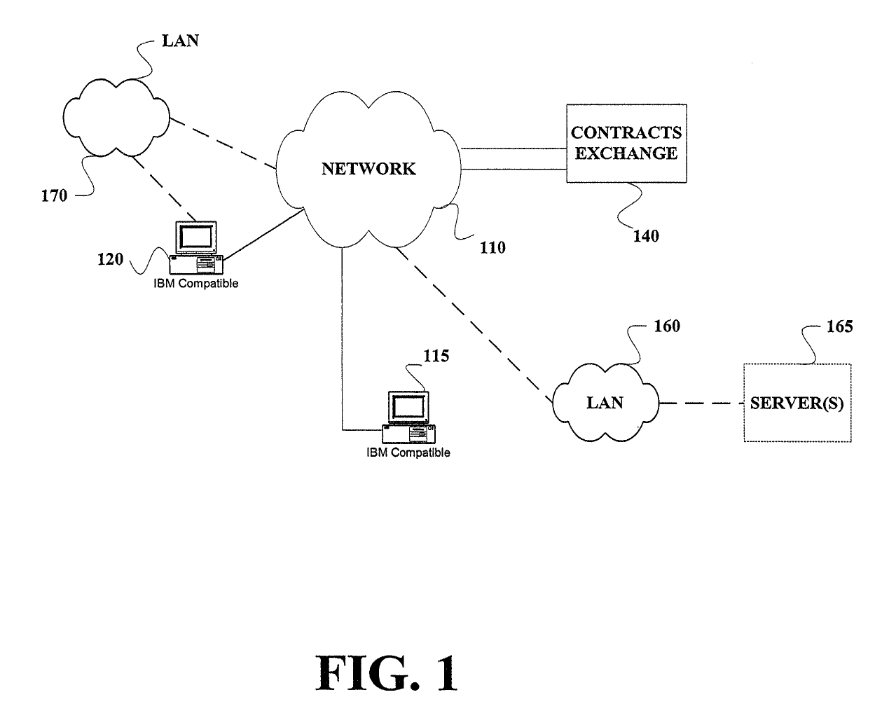

An example of a network arrangement in which the present invention may be deployed is illustrated in the schematic diagram of FIG. 1. In this arrangement a first party may operate a computing device, such as a personal computer (PC) illustrated as element 120, while a second party may operate a second computing device, for example a personal computer such as that illustrated as element 115. The invention is not limited to PCs. Any other intelligent device capable of communicating via a network and having input/output and data presentation capabilities, e.g., a handheld computing device, etc. is contemplated as well. These respective computing devices may be connectable to a network 1 10. This network could, for example, be a wide area network (WAN) such as the Internet, a wireless network that connects mobile phones and/or wireless Personal Digital Assistants (PDAs) or other forms and combinations of communication networks. The particular protocols of the networks are not germane to the present invention. The only significant aspect is that the multiple parties be both provided with some sort of communications network access to a document exchange, here illustrated as a contracts exchange 140. It should also be noted that the various computing devices 115 and 120 may alternatively be connected to the communications network via another network connection, for example the computing device 115 may be connected to a local area network (LAN) 160. One or more servers may be elements within that local area network or connected thereto. Computing device 120 may similarly be connected to a local area network and thereby be connected to network 1I 0. Again, the specific arrangement of the physical connection of the computing devices to the contracts exchange 140 is not significant so long as both parties to the document negotiation process have some communication access to the document exchange.

An exchange can be operated by a third party, that is a person or entity that is not a party to the transaction. Alternatively, a host could integrate a contract exchange with its existing infrastructure. In this way one of the parties to the transaction operates the exchange. In this latter arrangement data, such as member user information, can be passed from the host to the contract exchange. The transfers of such member information are maintained in a secure fashion.

As will be described in connection with the flow diagrams that follow, the arrangement illustrated in FIG. 1 provides an opportunity for a first user, such as a user at computing device 115, to create a contract on contract exchange 140. The user can then identify the appropriate second party, here the user of computing device 120, as being the intended recipient of the proposed contract. The second user can then access the document at the document exchange and review the document's contents. The first party may designate the extent to which the second party is entitled to propose revisions to the document. This aspect of the invention will be described in detail later. However, presuming that the second party is permitted to engage in a negotiation with regard to the contents of the document, the present invention provides the capability of having the second party import the contents of the document to the second computing device where it can be reviewed and where proposed edits can be inserted into the document. The revised document can then be exported to the contract exchange. At that time the exchange creates a document revision history which will include the changes proposed by the second party as well as any comments that are submitted by the second party and intended to facilitate the first party's understanding and acceptance of the proposed changes. For example the comments might explain/justify the proposed revisions.

When the first party reviews the document, the contracts exchange 140 shows the proposed changes in a format whereby they are easily discernible by the first party, for example a redline format or the like. In one embodiment the second party relinquishes control of the document at which time the first party now has control over the document and its contents. The first party can choose to accept the revisions proposed by the second party or make further revisions to the document. This iterative process can go back and forth until the parties come to an agreement as to the final content of the document or until the parties agree to stop the negotiation process.

While the embodiment shown in FIG. 1 presents two parties negotiating a document, it should be understood that more than two parties can participate in the negotiation process. Also one or more of the parties may each be represented by one or more individual users co-located or at disparate locations. These users can be networked to one another, but need not be to take advantage of the present invention.

The protocols of the present invention can be modified so as to determine an access, edit, and approve control arrangement whereby only one of the multiple parties has access and edit capabilities at any given time thereby assuring that when a party does edit the document they are editing the most recent version of the document.

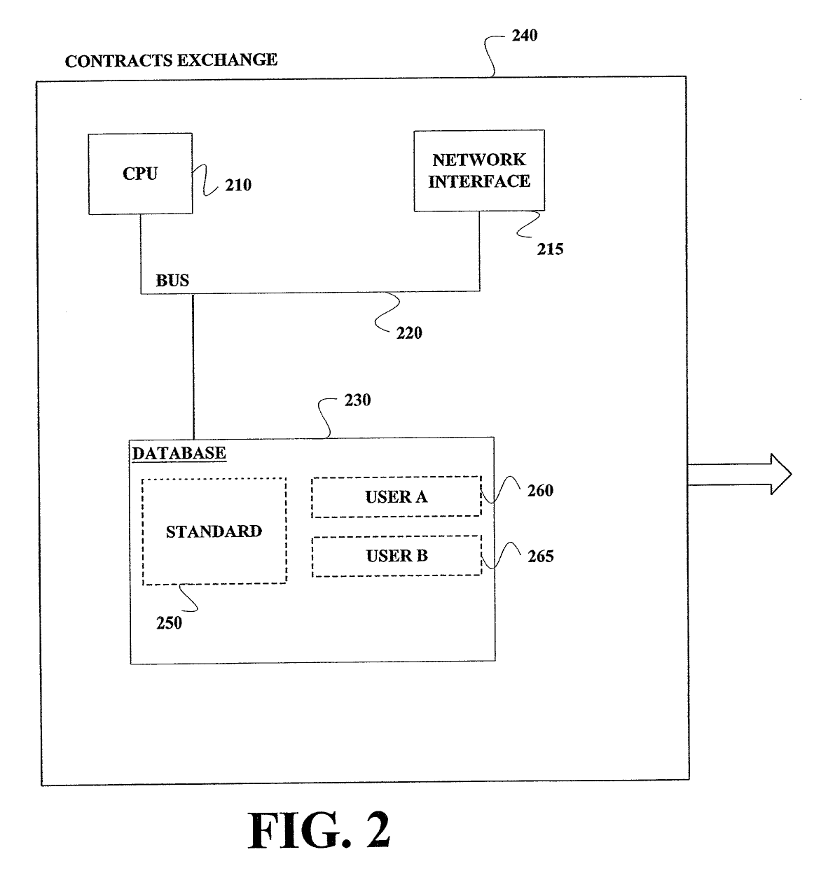

The document exchange, in FIG. 1 a contracts exchange, facilitates the electronic negotiation process. An example of a potential arrangement for a contracts exchange is illustrated in the block diagram of FIG. 2. The contracts exchange 240 may comprise a CPU 210, a network interface 215 and a memory or repository shown herein as database 230 interconnected with one another via a bus mechanism 220. While the remainder of this description refers to a database, the inventors contemplate that any electronic storage technique suitable for storing these types of data will be within the scope of their invention. The CPU 210 can comprise one or multiple processors. The network interface can be provided so as to present access to a local area network, to a wide area network or to many different networks having different protocols. The bus architecture can be selected so as to optimize the connectivity between the processing arrangement, the interface and the memory arrangement as represented by database 230. As indicated, the database is representative of memory generally and this memory can store the application programs necessary to effectuate the functionality hereinafter described. In addition the memory stores content useful in performing such functionality. In accordance with the present invention the database encompasses many different memory configurations such as a single database structure or multiple distributed databases but is not limited thereto. The significance of the database itself is merely the existence of a memory architecture into which the contracts exchange operator can store certain content. In particular, the database may be designed to include multiple subdatabases such as a standard database 250 and databases associated with each of a plurality of users. In FIG. 2 this is illustrated as user A database 260 and user B database 265. As indicated above, these databases can be of a unitary structure or could be distributed. The user databases and standard database could be integrated within a single database structure. Alternatively, they could be designated as having separate database structures. Thus, it should be understood this is only one of many possible arrangements of processing, memory and transmission elements. The particular architecture is not considered limiting as to the scope of the present invention.

As will be described below, a standard database 250 within database 230 can comprise a plurality of standard contracts and/or a plurality of standard contract clauses which can form the starting point for constructing individualized contract content databases.

As an example the exchange operator, referred to as the host, can supply a plurality of standard and nonstandard language clauses to populate a clause database. The host can then use the clauses stored in the clause database to construct one or more standard contract templates. These templates for standard contracts can be stored in the standard database 250. Alternatively, the host could enter entire contracts as samples or standards into the standard database either in addition to or in place of entering the plurality of standard clauses. Finally, the host could create a standard database employing the standard clauses alone without creating contract templates, leaving it to the users to extract clauses of interest from the clause database for insertion into user specific databases. The various parties who are members of the exchange can then populate their own respective databases, e.g., user A database 260, using content from the standard database and/or using their own content. These processes of populating the standard database and the user databases will be described in further detail below. It should be appreciated that a given party may desire to participate in multiple exchange environments. For example, company A may want to participate in an exchange for RFPs, a contracts' exchange and a publications' exchange. This could be facilitated by providing a global registry to permit the party to be member of multiple exchanges. Through this registry the party can select and register with multiple exchanges. In addition, access control to the various exchanges can be run through this registry as well.

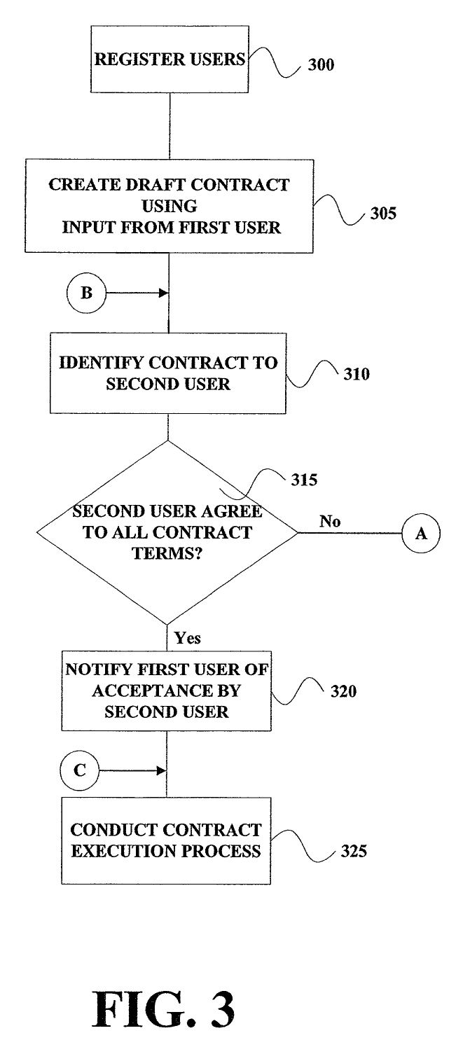

The following description of the flow charts of FIGS. 3-5 will assist in understanding the general nature of the electronic negotiation process that can be performed utilizing the configuration illustrated in FIGS. 1 and 2.

As the process begins in FIG. 3 at step 300 the exchange registers one or more users. The registration of users can occur at different times. For instance, the initiator of the negotiation process may perform an initial registration with the exchange. It should be understood that a “user” can be a member company or organization or the individual users who are employed by, are associated with, or are agents for the member company or organization. The registration may provide information about the initiator and may include setting up an account with the exchange. In connection with establishing the account, certain access procedures may be determined as the user is registered. These access procedures can include such things as providing membership and password ID protection so as to limit access by third parties. The other parties to the transaction can be subsequently registered by the system as the contract proposal or document proposal is in condition for presentation to those parties. The initiator can provide identification information about the users who will be permitted access to the information and can provide information about the access privileges for those individuals, such as determining the extent to which the individuals are permitted to edit or submit edit proposals. Member company users of the contract exchange must be created by defining individuals involved in the contract process and populating user profiles for each of these individuals. The types of information which would be utilized in such a user profile include: user name; user job title; user password; user e-mail address; and user phone number. Optimally the contract exchange captures any pertinent information that the host already has about given users to auto-populate a user profile. This reduces the amount of manual data entry necessary to create the user profiles. In addition to defining the above elements of the user profile, a given member company user can designate that each of the individual users associated therewith have certain roles assigned to them that will be specific to a given contracts exchange application. The ability to perform particular actions on contract templates, proposals and clauses will be defined by the users' roles. Some roles may allow users to view clauses and not edit them. Other users may be able to edit clauses, but may need to seek final approval with respect to certain ones of those clauses.

User profiles may be modifiable depending on the type of contract which is involved. For example an individual user may have certain authorities with respect to contracts involving a given prospect where multiple transactions of the same type are undertaken with that prospect. However, the user may not have the same level of authorities or negotiation privileges when it comes to a business transaction involving another party. Thus the user profiles can be modified in connection with the roles assigned to users on a contract-type basis, on a prospect basis or on some combination as well.

The other users can register with the system as they are presented with access to the exchange. For instance, these users might receive an e-mail message with a link to the registration process. The activation of the link by the additional parties would then lead them to access that portion of the exchange which provides registration procedures. The registration procedure would also then be associated with the particular document or documents which the initiator wishes to convey to the other party. Thus, the operation referred to in step 300 can occur either at the beginning of the process or be spread throughout the process of operation upon a particular document.

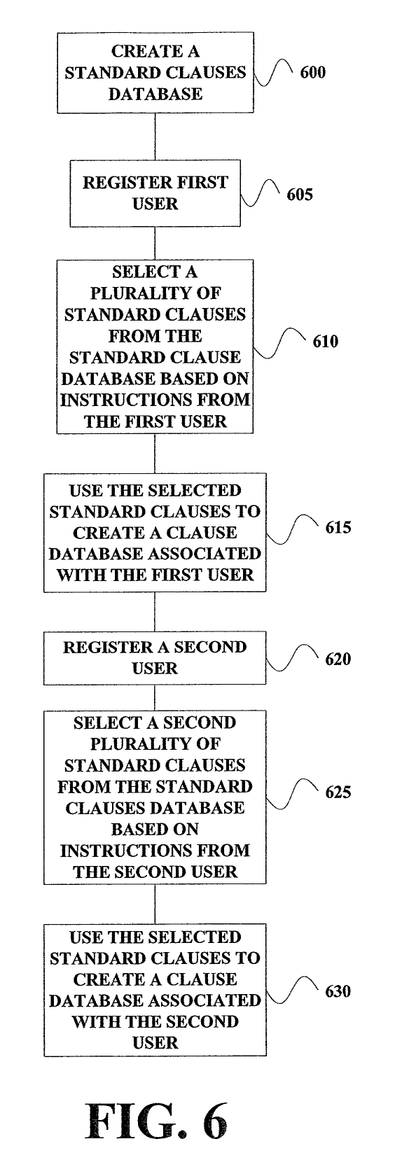

After an initiator has registered with the exchange the initiator can create a draft contract using input from that initiator or first party, step 305. The creation of the draft document will be described in greater detail with respect to FIGS. 6 to 8 which present exemplary embodiments for establishing the draft document, here a contract. In this embodiment directed to documents which are contracts, the system then identifies the contract to a second user, step 310. For example, once a party creates a contract proposal, such as by completing all standard contract template details, the party distributes the contract to the prospect or routes the contract proposal internally to be reviewed and approved by a user having the ability to distribute contract proposals to customers. Prior to distributing a contract on-line a prospect user will have to be defined in the contract exchange. If the prospect contact exists on the exchange generally but does not yet exist in the particular contract exchange the prospect contact will need to register with the contract exchange. The creator can also specify multiple prospect contacts who should receive the e-mail notification. The party has the ability to then attach additional documents at the point that the contract is distributed to the prospect. It should be recognized that a given contract creator could send multiple copies of the initial contract to multiple parties thereby creating a bidding process amongst the multiple parties over a particular transaction. It could then maintain these as separate contract negotiations which are accessible for comparison purposes. Each of these negotiations would undergo the remaining process steps of FIGS. 3 to 5.

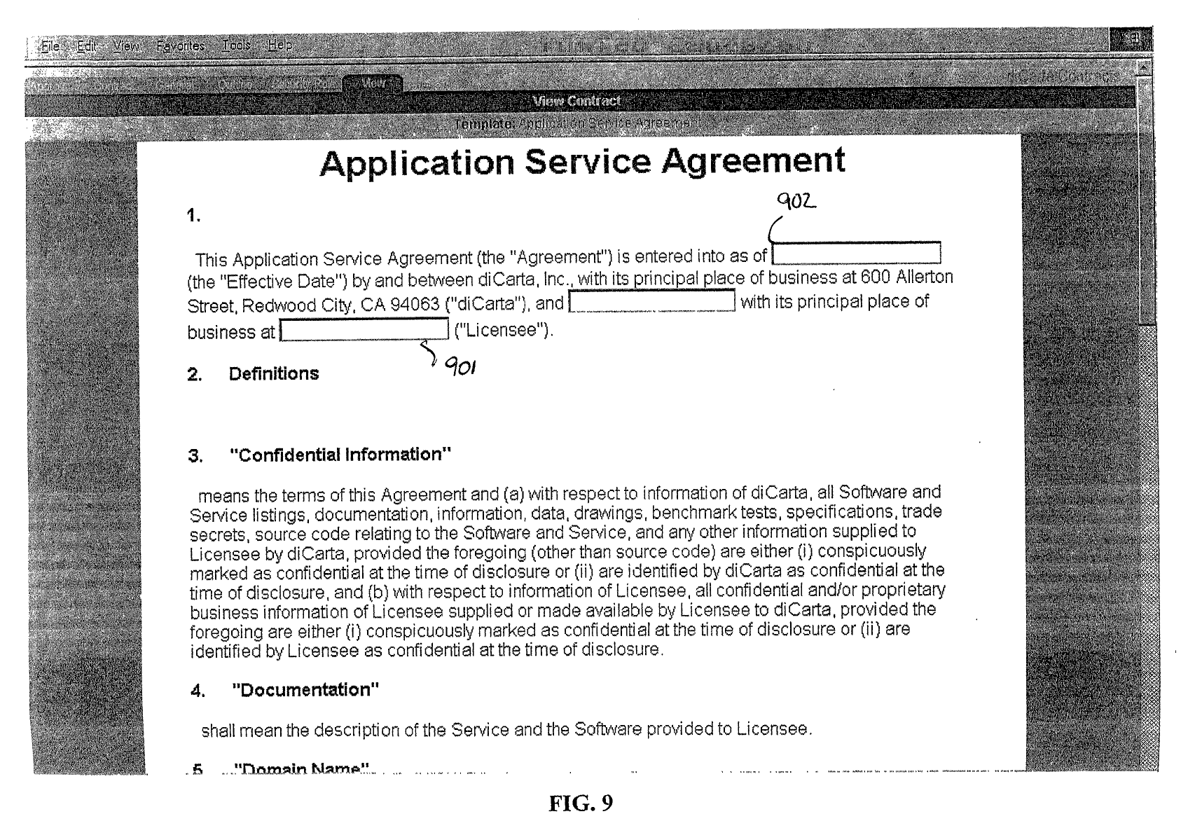

In this operation as suggested above the exchange can present an electronic message, such as an e-mail, to the intended recipient of the document. That electronic message can contain a link to the document exchange. Upon activation of that link the second user or party is brought into a login operation whereby the second user provides information by which it is identified and then granted access to the document in question. Alternatively, the second user may be asked to register as described above. The interface to the users for all of these operations will be described below with reference to example interfaces shown in FIGS. 9 to 17.

Once the second user has been provided with access to the document the second user can make a determination as to whether they decide to accept the document in its present form or wish to further negotiate the contents of the document. Thus, at decision step 315 it is determined whether the second user agrees to all of the document's content, here all of the terms of the contract. If the user does agree then the process proceeds to step 320 where the first user is then notified of the acceptance by the second user. The transaction can then be concluded by conducting an execution process, step 325. This execution process can take the form of exchanging electronic signatures on the document. For example, parties will have the ability to electronically sign all contracts in a legally binding fashion. Electronic signature technology allows for user authentication through access procedures. Alternatively, digital signing technology may be provided utilizing partnerships with certificate authorities such as VeriSign. A combination of cipher and asynchronous key technologies may be utilized to further ensure accurate signature validation. Upon execution of a contract by both parties using an electronic signature, a read-only version of the contract should be generated and a watermark can be placed on the read-only file. Alternatively the respective parties could respectively import final versions of the document to their own computing systems, execute hard copies of the document, and exchange those executed documents.

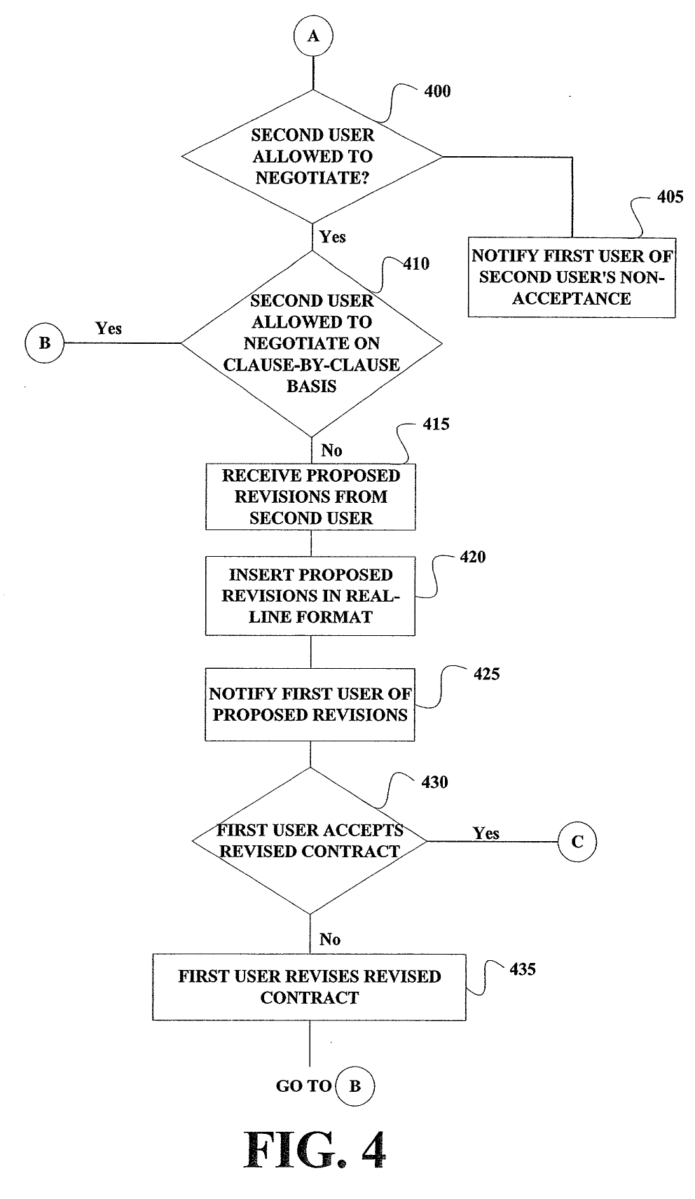

If, however, the second user does not agree to all of the contract terms, then the process continues as illustrated in FIG. 4 at point A, leading to the decision step 400. It is determined at that step whether the second user is permitted to negotiate the contents of the document. In certain circumstances the initiator of the contract process may determine that the recipient of the contract will have no negotiation privileges whatsoever. In that circumstance the contract is presented “as is” and the only option for the recipient is either to accept or reject the proposal. This is reflected in FIG. 4 by the “NO” decision branch of step 400 which leads to step 405 in which the first user is notified of the second user's non-acceptance of the proposed document.

If the second user is permitted to negotiate, the process proceeds to step 410 where a further decision is made as to whether the second user is allowed to negotiate the document on a part-by-part basis. In the present example of a contract the question is whether the second user is permitted to comment on or propose revisions to the contract on a clause-by-clause basis. If the answer to that question is NO, this implies that the user has some negotiation privileges but can only comment on the contract as a whole, and not directly propose revisions on a clause-by-clause basis. The second user then may provide proposed revisions which are received by the exchange in step 415. The proposed revisions are inserted in redline format, step 420. The first user is notified of the second user's proposed revisions, step 425. At this time the second user can be designated as having released the revised document to the first user. Under these circumstances the second user has relinquished control of the document to the first user so that any further edits that occur at that time will only be from the first user or parties designated as having edit privileges by the first user. In the next step it is determined whether the first user accepts the revised contract, step 430. If the first user does accept the revised contract then the process proceeds to branch point C which is shown on FIG. 3, which leads to the step of execution of the document, step 325. If the first user does not accept the second user's proposed revisions, then the process proceeds to step 435 where the first user can comment upon and/or revise the revised contract. If the first user determines that it wishes to take this action rather than abandon the negotiation process altogether, the process proceeds according to branch D which leads to step 315 in FIG. 3. Thus an iterative process is created which represents a negotiation of the content of the document electronically via the exchange which in turn controls access to the document and controls edit privileges with respect to the document as well.

After the first user has revised the contract and released it to the second user the second user can be sure that they have the up-to-date version of the document and the first user has relinquished control of the document for editing purposes to the second user. This iterative process will continue until the parties either successfully conclude the negotiation or decide to terminate the negotiation.

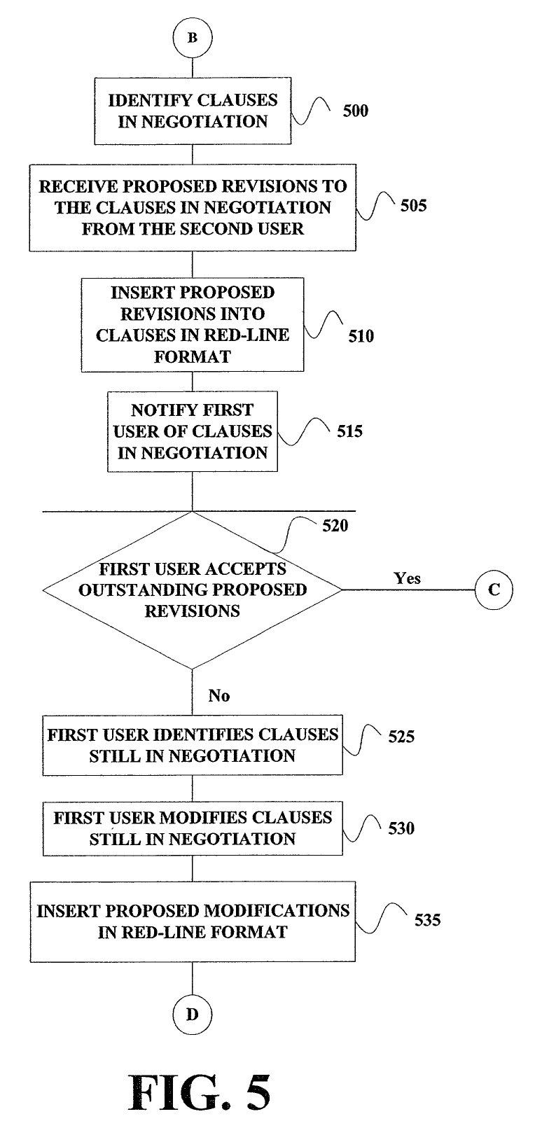

The first user may determine in some circumstances to permit the second user to negotiate the contract on a clause-by-clause basis as represented by the decision step 410. In that circumstance the process follows branch B to the flow steps of FIG. 5. In this circumstance the second user, having been granted the ability to negotiate on a clause-byclause basis identifies those clauses that remain or need to be negotiated. For example the contract or document may include multiple parts many of which the second user is in full agreement with. The second user can designate those parts as “agreed to” leaving the undesignated clauses in negotiation. Alternatively, the second user can specifically designate clauses as being in negotiation and thereby imply that the undesignated clauses are agreed to.

Once the clauses in negotiation are identified the exchange receives proposed revisions to one or more of those clauses from the second user, step 505. The proposed revisions are inserted into the clauses in a redline format, step 510. The exchange then notifies the first user of those portions or clauses which are in negotiation. The system also provides the negotiating party the option of sending comments about a clause in addition to or in place of proposed revisions. Thus the negotiation continues even in the absence of proposed substitute language.

In decision step 520 the first user is determined to either accept the outstanding proposed revisions or reject them. If the user accepts them then the process follows branch C back to FIG. 3 leading to the execution process. If, however, the first user does not accept the outstanding proposed revisions, the first user can identify those clauses that still remain in negotiation. For example, the first user may accept a number of the clauses as revised by the second user but still take issue with some of the remaining clauses. Thus, Step 525 captures the notion of identifying those issues that still remain to be negotiated. Once those clauses that are still to be negotiated are identified, the first user can modify those clauses, step 530. The exchange then inserts the first user's proposed modifications in redline format, step 535. Furthermore, as described above the first party can put in comments in addition to or in place of proposed modifications. The process then branches along branch D back to FIG. 3 whereby the second user again gets an opportunity to take a look at the contract and the iterative process continues. The iterative process ends when either both parties agree on the content of the document or the parties decide to otherwise terminate the negotiation.

It should be recognized that FIGS. 3 to 5 present merely one example of a flow for the negotiation process as between two parties utilizing the contract exchange. These steps can be rearranged so as to provide the same negotiating effect without adversely impacting upon the efficacy of the present invention. Similarly, the process could be modified to reflect that multiple users could have negotiation privileges. That is, the document might be the responsibility of three or more parties. Then three or more parties and their respective individual users would have to have access to the document and the access controls would be modified to reflect the number of users who would be responsible for the final content of the document.

As described above the present invention contemplates that a given party to the transaction may in fact have multiple users associated with that party. For instance, a first company initiating a business transaction with a second company may employ a team of individuals as part of the negotiation process. The contract exchange is flexible enough so that the first party, in this latter example the company, can identify multiple users to have access privileges to the document on behalf of the party. The party may also designate different access and edit privileges for each of the users of that team. For instance, a user might be designated a basic user with the ability to access contract templates and populate contract details but without the power to negotiate. Another potential role would include the ability to approve the submission of a standard contract proposal with no modifications to a prospect. A third possible role would provide a user with the ability to edit contractual language by, for instance, accessing the clause database to view alternative clauses (if available) and/or add language to a contract proposal and delete language from a contract proposal. This is further flexible in that a user may have authority to edit some clauses and not others. A fourth potential role would provide a user with the ability to approve the submission of a contract proposal that has been modified or negotiated to a prospect. A fifth and sixth role would relate to the powers to execute a contract. For instance a standard executor would have the ability to accept and execute a contract that has had no modifications. A negotiated contract executor would have the ability to accept and execute a contract that has been negotiated and/or modified. It should also be recognized that a given user may be assigned multiple roles, that is multiple access and edit privileges and responsibilities.

All of these roles will provide a user with a flexibility to assign multiple team members to a negotiation and to allocate their responsibilities. In one of the embodiments of the present invention the user having authority to assign roles may do so on a dynamic basis, i.e., the role of an individual user may be changed during a negotiation process. Additionally a given individual user may have different levels of responsibilities for different transactions that are concurrent. For example an individual user may have edit privileges on contracts below a certain dollar amount and on other contracts of larger dollar amounts the edit privileges may be curtailed. Therefore, the individual may be on multiple negotiation teams at the same time. Thus the process flow described above could be modified to take into account the involvement of multiple users of a given party to take advantage of the various role assignments.

FIGS. 1 to 8 thereby provide illustrations representative of an exemplary embodiment of the present invention. Various aspects of the invention as described in relationship to those figures can be modified so as to meet various configuration requirements of individual users. One such example is that the present invention can be deployed either by an exchange which can act as a host to many users who will initiate contract negotiation processes or alternatively the present invention can be employed by a single enterprise which executes a number of document negotiations with various parties. The same negotiation concepts apply whether the invention is deployed in the exchange or for a single enterprise. Additionally, it is envisioned that the present invention can be employed to facilitate the negotiation of documents such as those described above which require an interplay between two or more parties who are attempting to come to terms as to the final content of a given document.

It should also be recognized, that when deployed the extent to which the present invention is fully utilized by all of the parties to a given transaction will vary depending on the types of parties involved and their proclivities for bearing responsibility for generating revisions to documents. In particular, in many industries it is expected that a given one of the parties, for example, a vendor, bears the responsibility for presenting the proposal and often times is the party who physically deals with providing revisions to the proposal's content. These revisions can come either from the vendors' attempt to negotiate a point or can come m response to comments received by the vendor from a buyer. In those circumstances most, if not all, of the revisions are entered by one of the parties even though both parties have access to the document via the exchange. The invention still provides value to both parties even when the architecture is not utilized to its fullest by the second party. First, the first party still receives all of the benefits of the ease for constructing a proposal provided by the arrangement of the present invention. Secondly the second party, while they may not take responsibility for the editing process, can observe the present state of the contracts at any time via access to the exchange, and furthermore can see proposed changes to the document in real time. This obviates the delay typically associated with a contract negotiation scheme where one party bears responsibility for inserting modifications to the proposal.

Member companies have the ability to arrange real-time on-line chats with prospects to review contracts and clauses. Simultaneous viewing of the contracts and particular clauses is allowed to facilitate this real-time chat environment among a number of participating users at both the prospect and member company. In addition the member company has the ability to carry on both internal and external discussions during this realtime chat. That is, each party is provided with the capability of having a private chat as between the users associated with that company to conduct a chat session amongst themselves while the real-time negotiation goes on. Furthermore, member company users have the ability to post comments on behalf of the prospect to allow for telephone calls in which the prospect or member company provides commentary that is not proposed utilizing the electronic tools as the communication tool.

It should also be recognized that the execution process can be tailored to fit a given party's needs. However, to the extent that execution of the contract is intended to be done electronically, any one of a number of different digital signature/document safety techniques can be employed to assist the users in completing the negotiation.

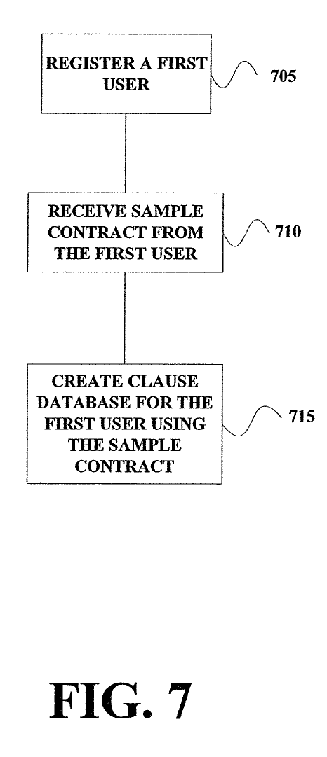

FIGS. 6 and 7 are flow diagrams representative of examples of how to create the databases which facilitate the negotiation process. In the first example, with reference to FIG. 6 a host for exchange can create a standard clause memory store which as in this example, can be a database, step 600. The standard clause database can be created in a number of different ways. For example the host may load a number of standard contract templates into a database. Alternatively, the host can partition standard contracts or templates into their respective clauses and store these separate clauses. The manner in which the standard clauses are stored can be varied. For example, the arrangement of clauses and association with given standard contracts can be done in any manner suitable based upon the selection of the type of database to be used within the system architecture.

Once the standard clause database has been created a system can register a first user, step 605. That first user, once registered, is provided with the authority to create or supplement a user specific clause database. In that vein the user selects one or more standard clauses from the standard clause database by providing instructions to the exchange, step 610. The selected standard clauses are used to create a clause database associated with the first user, step 615. As has been suggested above, the first user can supplement the contents of the first user's clause database by accessing the standard clause database and selecting one or more additional clauses.

The system or exchange can then register a second user, step 620. The second user can select a second plurality of standard clauses from the standard clauses database using instructions from their access point into the exchange, step 625. The selected standard clauses are then used to create a clause database associated with the second user, step 630. Thus the exchange can be used to create multiple user specific databases where the user specific databases can have separate standard clauses associated therewith. The contents of a given user specific database may overlap to some degree with that of another user. However, the present invention enables different users to tailor their clause specific databases to address the issues that are germane to that parties' business transactions and the way in which they go about those transactions.

FIG. 7 refers to a process flow by which a user can generate a user specific database. In this variation on the present invention the user generates a clause specific database with documents already usable by the first party. In this operation the exchange registers a first user, step 705. Subsequent to registering the user, the exchange receives a sample contract from the first user, step 710. The exchange can then parse the contract into its respective clauses to create a clause database for the user using the sample contract, 715. Alternatively, the exchange can receive standard clauses from the user without reference to a standard clause database maintained on the exchange. That is, the user may have a series of standard clauses already gathered in connection with the user's business transactions and the user is provided with the opportunity to enter those standard clauses directly into the user's specific database.

It should be clear to one of ordinary skill in the art that it would be possible for a user to create a user specific database by combining the techniques of FIGS. 6 and 7. More specifically, a given user's specific database may incorporate standard clauses derived from a standard clause database associated with the host or exchange and may also refer to clauses entered more directly by the user either from standard contracts associated with the user or standard clauses associated with the user. Thus the present invention provides an exchange that makes the accumulation of standard document information, here contract clauses, less complex and more easy to use to construct standard contract templates.

A series of pre-defined standard contract templates will be available to users of the present invention. These templates can include all standard contracts that a company uses and act as a starting point for all processes involving an unexecuted contract. These templates will be created in one of the following ways. The templates can be structured by accessing a clause database and selecting individual clauses that together constitute a standard contract template. Template creation tools are provided to the user to compile and present these clauses as a standard contract template. Alternatively if an entire contract was stored in a clause database a standard contract template can be created by selecting that particular document. As a third alternative, if a host has created a global template, member companies can access this global template and save it as a standard contract template to be associated with that member company. The member company also has the opportunity to modify such a global template to make it more company specific.

A host or member company has the ability to customize the structure of the template to represent their existing contracts. For example, the company could have the ability to place a signature box at the head of the contract as well as at the end if they so choose. In addition, a member company has the ability to import their logo and place it at the head of the contract template.

The establishment of a clause database provides the host or member company with a new way to consolidate, organize and manage their contractual language. The clause database comprised of specific contract clauses will serve as a foundation for all member company contracts and is the engine powering the contract negotiation process.

To populate a clause database the contract exchange provides tools that require the host or member company to do as little manual data entry as possible especially where this data entry would be redundant to a process that is currently in place. For example, many companies have created a static library of standard alternative clauses in word processing application format such as MS Word . The present invention provides the capability of allowing the company to batch load clauses that are currently stored in such a static library. When batch loading documents that contain multiple contract clauses the tools of the present invention allow the member company to distinguish each clause and thus store independent clauses in the member company or member specific database. Alternatively, users can be provided with the ability to directly input individual clauses into the clause database that do not currently exist in another format. Finally, any combination of these options can be provided to a member company user to allow them to populate the clause database. In one embodiment of the present invention a clause consists of at least three portions, a clause title, clause text and user-defmed fields. The present invention permits the insertion of clauses that are not strictly text based. In particular, the clause database handles tables that delineate contract details such as payment schedules or pricing. These tables can consist of multiple columns and rows, column headers and row titles. The matrix may include text as well as user defined fields.

Member companies are also provided with the capability of assigning clause summaries to each clause. The summaries are accessible whenever a user accesses the clause database during negotiation. The purpose of these summaries is to inform the user about differences between clauses or to remind the user of the origin of the language in a given clause. When the clause database is populated, particular fields within some clauses should be defined so that a contract exchange user can alter those fields when a user is populating a contract template. Examples of such fields might be company name, address etc. for prospects.

Upon entering a clause into the clause database a clause profile containing clausespecific information and a series of rules will be associated with each specific clause. The following will be input into the clause profile: A clause type and an approval workflow. The clause type will operate in conjunction with the roles assigned to certain users which will enable those users to take actions on only certain types of clauses or restrict users from taking any actions on certain types of clauses. As an example a user may be able to edit any clause within a contract proposal except those that have revenue recognition implications. Such clauses would then be flagged in a contract template and that particular user would not be allowed to edit those clauses. As for approval workflow, while a given user's role may give them the opportunity to perform an action on a clause, the action performed on that particular clause may include either legal or business considerations and therefore require approval from a higher authority before being legitimated. The clause profile will indicate if any additional approvals beyond that of the user performing the action are required. If an action is performed on a clause delineated as requiring additional approvals, the approval workflow will be initiated automatically and specified approvers will be notified. The approval levels will be delineated by role, not by individual people. Therefore, if a financial person of particular expertise is required to approve a modification to a clause, all users designated as having such a “role” will be able to approve that situation. The required approvals and chronology in which these approvals should be obtained will be defined in the clause profile. The clause database is also arranged to permit a host or a member company to store documents in their entirety if they choose. Thus the contract exchange need not force a given member company to break down a contract to a clause-level. In such a case however, the host or member company will only be able to negotiate at the contract level.

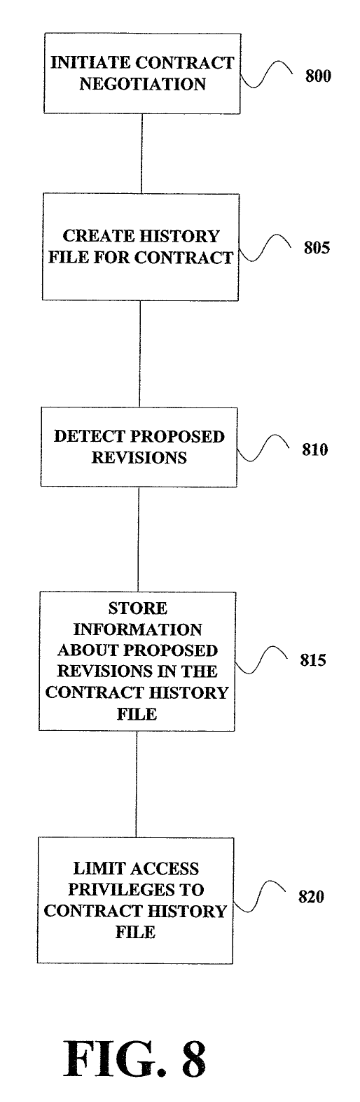

FIG. 8 provides a flow diagram of how an embodiment of the present invention can maintain a revision history with respect to the contract negotiation. Once the parties initiate the contract negotiation, step 800, the exchange creates a history file associated with the contract that is in negotiation, step 805. As the parties exchange revisions to the proposed contract, the exchange detects the proposed revisions, step 810. The exchange then stores information about the proposed revisions in a contract history file, step 815. The exchange limits access privileges to the contract's history file so that parties can review past history but cannot revise past history. This assures that the history of the contract revisions and any exchanged notes can be maintained in an incorruptible manner. Thus an accurate history of the negotiation process is created and maintained.

As illustrated in FIG. 1, the present invention is intended to operate in an enviroranent where users have access to processing devices such as PC 120. Such devices typically include processor and memory structure as well as display and data entry structure. Embodiments of the present invention provide user displays as part of a friendly user interface (graphical user interface—gui) which enables the user to more easily navigate the process to register users, create contract templates, create contract proposals and to conduct negotiations. In the figures that follow, FIGS. 9 to 17, sample screens of possible user interfaces are shown for explanatory purposes. These sample screens are meant to illustrate how information could be presented to an end user so as to make the operation of the system and the completion of the methods easier for an intended end user.

In the scenario which will be described in relationship to FIGS. 9 to 17 it is presumed in this embodiment that the user has already created standard contract templates that have been associated with a user specific or member specific database. In this instance a member will be considered a member company and each member company may have multiple users who can have varying degrees of access to the negotiation aspect of the contract exchange. When a user who is identified with the appropriate privileges for drafting or selecting a contract obtains access to the exchange they are provided with the option of selecting an appropriate contract template out of the user's database. This can be accomplished via one or more screens presented to the user providing a catalog or a listing of the available contract templates. Upon selection of one of those templates from the catalog or list the system identifies the selected contract template as the one which is to form the starting point of the contract creation process. The user, at this point designated a creator, will then complete contract details. Such details may include information about the other party or prospect and deal specific information. On some occasions the prospects will be members of the same exchange. Even so it is possible that while the prospect is a member of the exchange it may not yet be a member of the contract exchange. In such circumstance then a prospect user would have to define a user profile within the contract exchange including the assignment of particular roles to different users. Again it is assumed that a given prospect would be another member company and the users associated with that member company would be assigned different roles or access privileges. Once a prospect company exists within the contract exchange a creator will be able to automatically populate contract template details relating to that prospect. If a creator is unable to complete the drafting process in one sitting, they will have the ability to save a contract or contracts in progress so that they can return to them at a later time and continue work without losing any previously input information. Upon completion of all contract details the creator, depending upon the roles assigned to the creator will be able to distribute the contract proposal to the prospect. If the creator's role does not allocate that user the right to submit a contract proposal to a prospect then the creator will have to route the contract proposal to another user associated with the member who has the appropriate authority to issue the proposal.

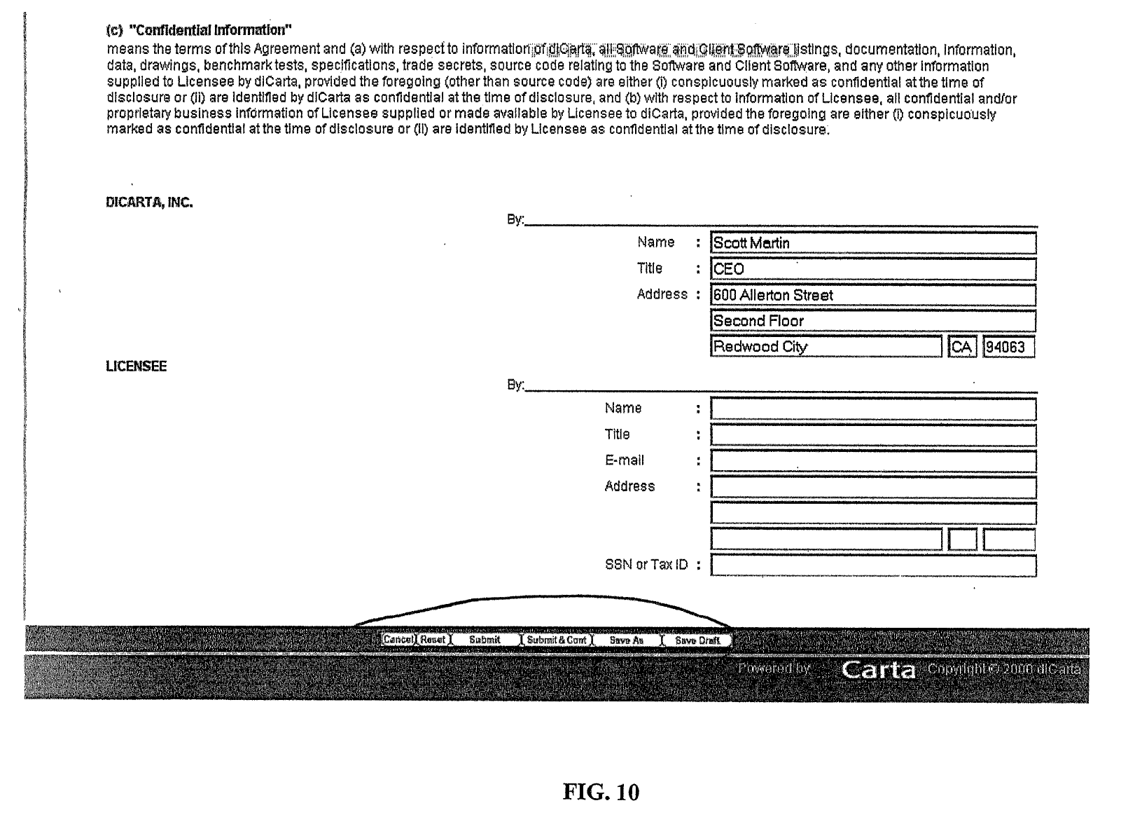

FIG. 9 of the present application illustrates an interface example where an application service agreement has been selected as the contract template by the user. As can be seen, a number of different fields within the template need to be completed so as to complete the creation of the draft contract. For example portion 901 of the application service agreement relates to an identification of the date of the agreement; portion 902 relates to the business address of one of the parties. This suggests that the information can either be added to the field by the creator by manual entry, such as by manipulating a keyboard or by activating a voice recognition system, or automatically by populating the field with information about the prospect from the exchanges' database. FIG. 10 illustrates another interface screen. In this one links are shown in the document which provide the user the opportunity to automatically save or send the document to the prospect.

When the creator submits the contract proposal to the prospect, the creator determines whether the prospect will have the ability to negotiate the contract proposal at all and if so whether they will only be able to negotiate at the contract level or whether they will be able to negotiate on a clause-by-clause level. Even if the contract creator permits a user to negotiate on a clause-by-clause level, it is possible that the system controls can be set to designate certain contract clauses as non-negotiable. Similarly, in the process of creating the contract, different users may have different editing capabilities in creating a draft proposal. Certain of the clauses accessible from the user clause database may be designated as non-editable, that is, a user will not be permitted to change the content of that clause as the member has decided that the clause in question must remain with the language already presented without change.

As an aside, it should be noted that based on the structure of the arrangement a user can construct multiple contract templates having one or more identical clauses in them, for example, an alternative dispute resolution clause. Where the member subsequently decides to revise or update such a repeated clause in all of it's contracts, the system permits the user to modify the standard clause and this modified or replacement clause now stands in the place of its predecessor clause and will automatically appear in each contract template which calls for that particular clause. This avoids the need for having to go through each and every contract template and making the same language changes over and over again as a member updates its clauses.

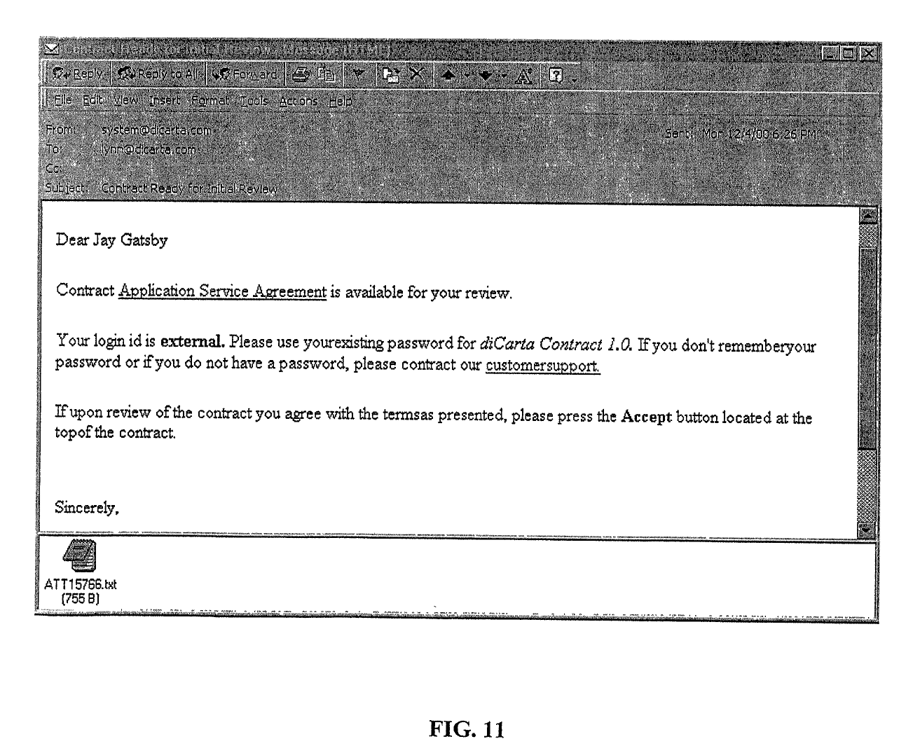

In one embodiment of the present invention when the creator distributes the contract proposal the prospect or prospects will receive an e-mail that notifies them that the proposal is available for their view. An example of such an e-mail is illustrated in FIG. 11. The e-mail can contain an active hyperlink within the notification. If the prospect selects or clicks on the hyperlink they will be presented with the log-on process by which they can observe the contract on-line. An example of such a hyperlink is highlighted in FIG. 11.

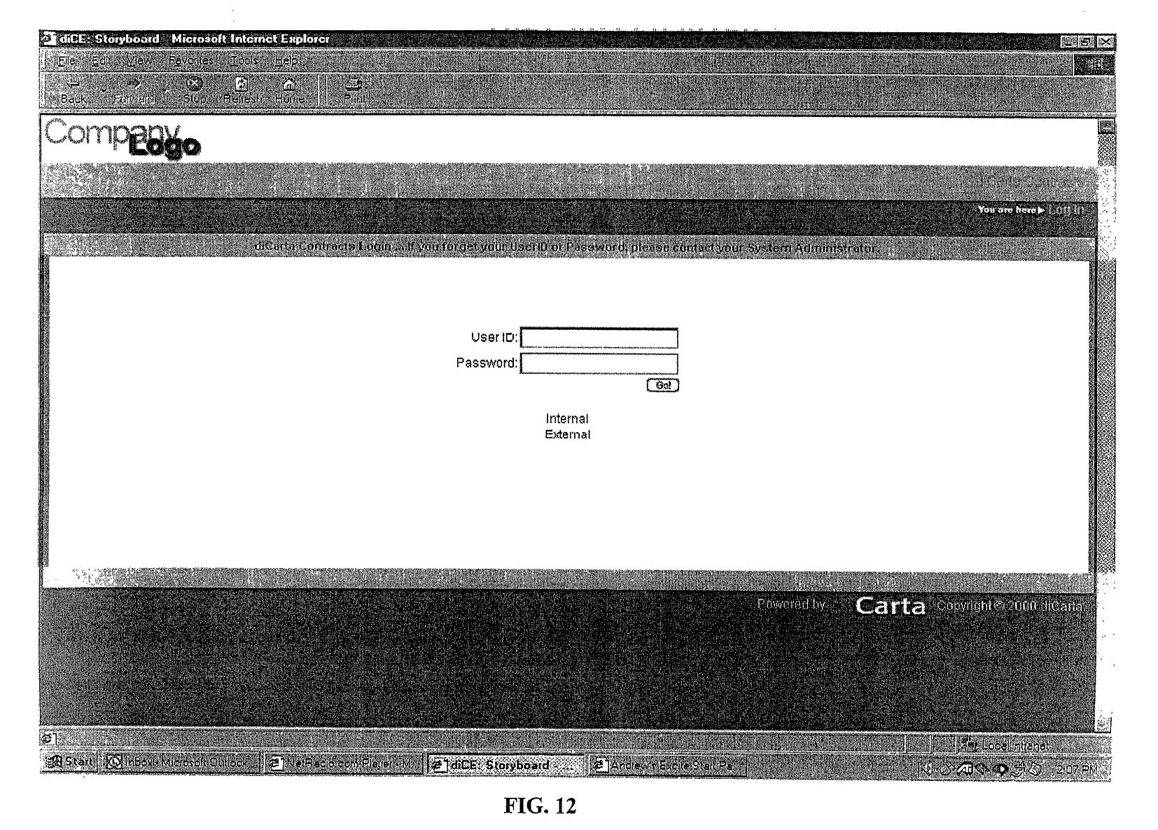

Upon receiving such an e-mail notification that the contract proposal is available for review, the prospect can select or click on the hyperlink and arrive at a page, such as a web page or other network document, which will present a log-in process for access to the exchange. If the prospect is not currently signed on to the exchange the page will prompt the prospect to enter their user ID and password such a prompt could appear as shown in the exemplative interface screen of FIG. 12. If a prospect has already entered their exchange user ID and password then they will not have to re-enter the information at this time.

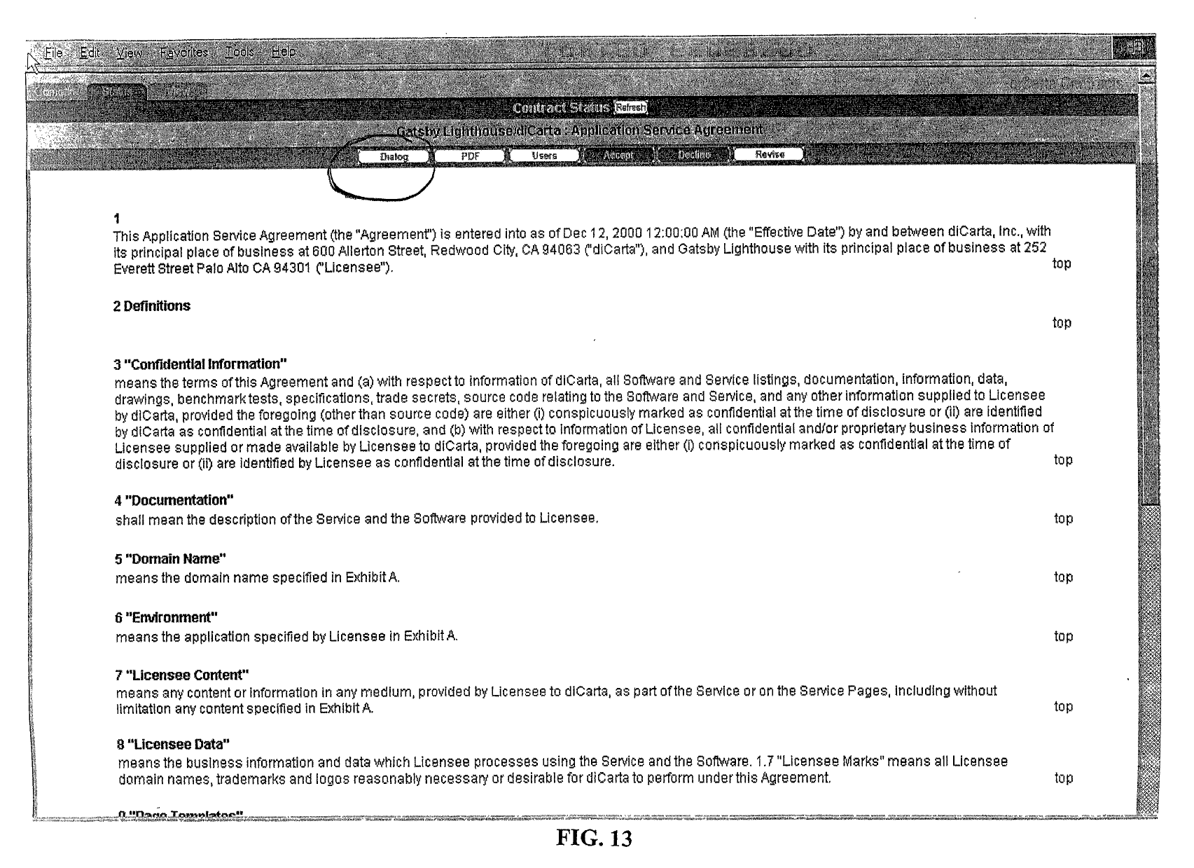

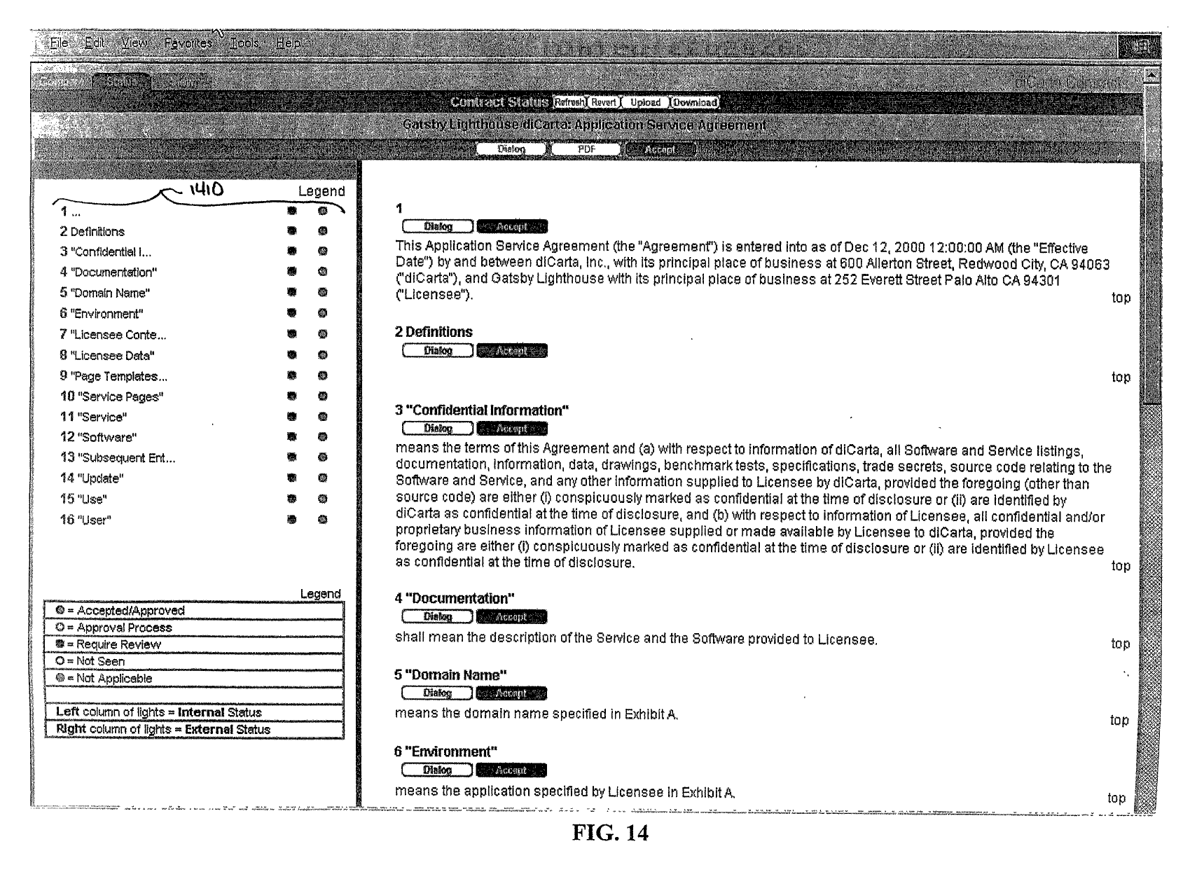

Upon entering the appropriate user ID and password, the prospect will access a screen that displays the contract proposal in its entirety (e.g., FIG. 13). The prospect will have the ability to accept the contract proposal or begin a discussion to clarify questions and/or propose the inclusion of new or revised clauses depending upon the access and edit privileges accorded to the prospect user. If the prospect does not accept the contract initially then the prospect will be able to press a “dialog” button and begin a discussion with the creator. Only those prospect users with the appropriate assigned roles will be able to negotiate the contract proposal. A prospect user that has a negotiator role capability will be permitted to view graphical representations of the changes that they suggest about a contract or specific clause. When the prospect begins a dialog one consistent conversation thread between the prospect and the creator will be created. This thread will track all commentary between negotiating parties. If a prospect has the ability to begin a dialog only at the contract level, the comment history will pertain to the entire contract proposal and only one conversation thread will exist per contract. If however, the prospect has the opportunity to begin a dialog on the clause level this comment history will be specific to particular clauses. In this case multiple conversation threads will be possible, but only one thread per clause will exist. Upon submission of comments by the prospect the creator will have notification that the contract proposal has been reviewed and that comments have been made. If the creator has allowed for clause-specific negotiation then the system provides for the capability of pinpointing clauses under negotiation and presenting the changes in a manner that is understandable to the creator. For example, a user interface screen such as that illustrated in FIG. 13 will provide the viewer with a presentation of two screens which can be toggled. One screen would show the entire contract with the most recent revisions enclosed and showing changes in a redline fashion. The second page presents only those clauses which are presently under negotiation. Furthermore, the interface can be adapted to present a list of all of the clauses in the contract and some symbolic representation associated with the list to indicate which of the clauses remain in negotiation. In the illustrated example the clauses are identified by number and those in negotiation are highlighted, such as by providing a different format (e.g., bold, different color, etc.). Those that remain in negotiation may be considered clauses that are being actively negotiated. Furthermore the screen can show the status of responsibility for the respective clauses in the document, that is who was the last party to have modified such a clause. This list of clauses and status is shown as element 1410 in the display illustrated in FIG. 14. In the illustrated example an icon or icons associated with the clause give an indication of which party “owns” responsibility for the clause, such as by illuminating a light or button in that party's column. If in permitting the parties to negotiate on a clause-by-clause basis, the negotiation only occurs on a contract level the status bar referred to above with respect to a list of the clauses will be modified so as to only indicate whether the burden of action lies with the creator or the prospect continuing the negotiation process. If a creator does not have a role assigned to them that allows them to further negotiate contractual language the user will have the ability to route the clause/contract and the associated comment history to another creator user that can move the negotiation process forward.

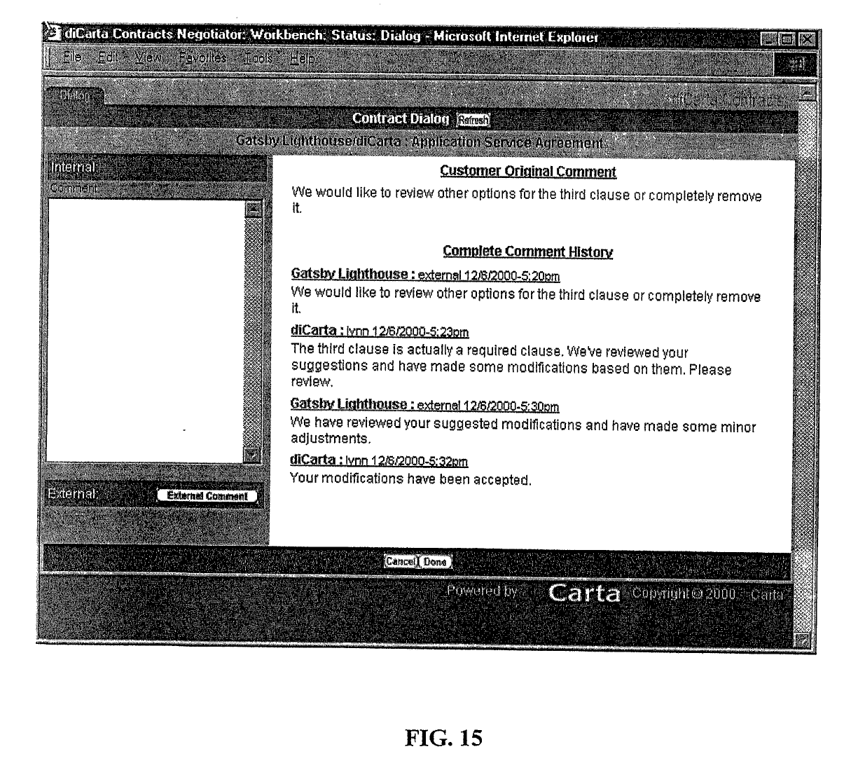

Users from either party to the negotiation will have the ability to view the comment history throughout the negotiation and to post comments to the other party at all stages in the process so as to allow for the ability to keep the other party updated as to the status of the negotiation internally. An example of a screen illustrating a listing of the comment history is illustrated in FIG. 15.

There are two aspects to the comment history. First there is a comment history which is accessible to both parties. Furthermore, the present invention provides that as for the users associated with a given party, that set of users may have their own set of “private” comments which are exchanges in the course of discussion over how to proceed with the negotiation. A given user's internal comments will not be accessible to anyone outside of the party. Thus there is segregation between the parties as to their internal comment history and there is a shared document comment history which forms part of the negotiation history associated with the document. Both of these types of comment history (internal and exchanged) are maintained for access to keep a complete history of the negotiation.

During the negotiation process both parties will have the ability to work on the contract proposal off-line by exporting the document from the contract exchange. Users will be able to use word processing application software such as MS Word to edit the document off-line and then re-import that document into the contract exchange. Upon re-importing the document to the exchange the application will be able to recognize differences between the re-imported document and the latest version of the contract proposal. Users will then be notified of all differences between the documents.

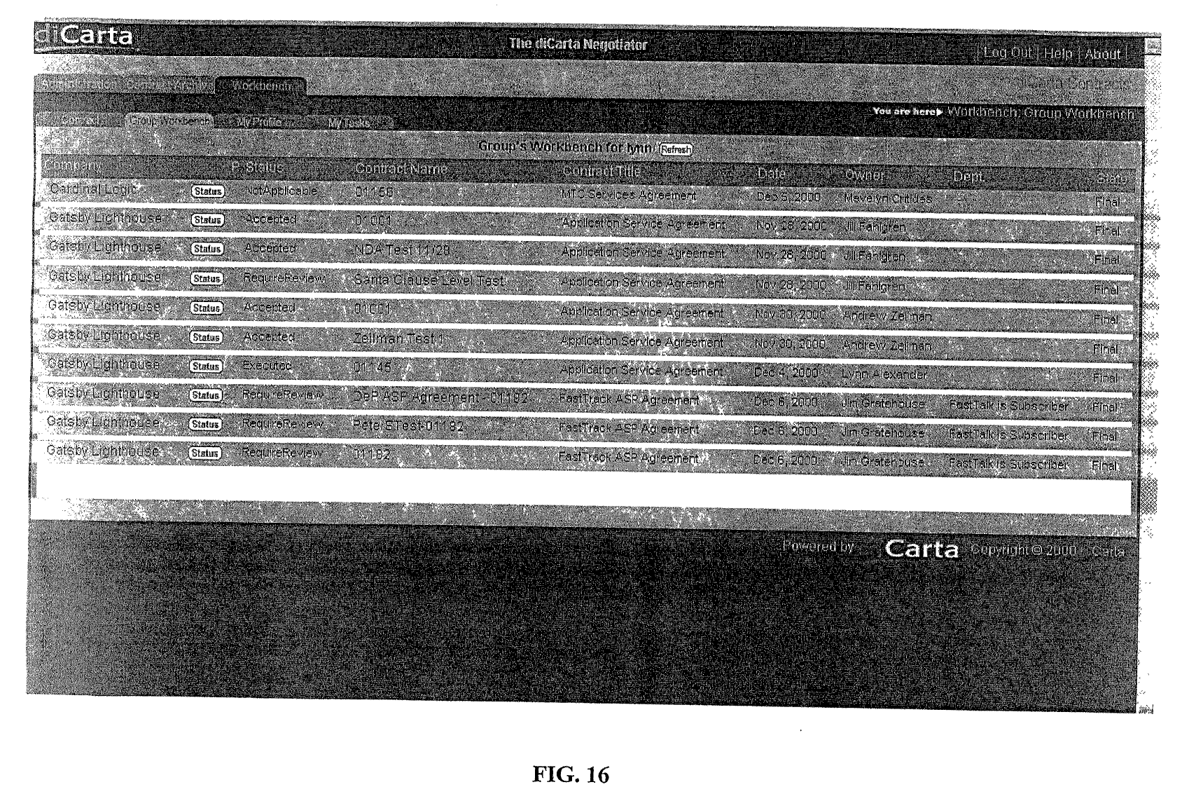

All users of the contract exchange will have a workbench in which they can view all outstanding tasks they have assigned to them. An example of a workbench is illustrated in FIG. 16. Users will be assigned to groups and will be able to view all tasks assigned to their given group. For example a chief financial officer could be assigned to a company wide group thereby allowing him or her to view all outstanding contract proposals within a company. Alternatively as shown within FIG. 16 the workbench for one person may include a number of different contracts or a number of specific clauses within given contracts that need to be addressed. This workbench tool allows for better monitoring of the status of the negotiation of the document as well as keeping track of the parties responsible for the next action items in regard to that document.

Users with the appropriate permissions are able to at all times view all outstanding contracts in both an on-line and off-line report. This outstanding contract report lists contracts under negotiation, not clauses. Particular clauses under negotiation are available to the user by drilling down on a given contract. The member user has multiple options for how to organize the outstanding contracts. For example, the presentation of the outstanding contracts could be organized by such creator defined criteria as the dollar size associated with a given contract, the prospect associated with a given contract, the contract type, or date for just a few options available to the creator.

Users having an appropriate permission are allowed to monitor contract activity that has occurred utilizing the contract exchange. A report of contract activity delineates the number of contracts distributed through the contract exchange and the number of contracts that were accepted without negotiation. Such a report can also note the number of contracts that were negotiated using the exchange. A negotiation is considered to begin when a prospect responds to a proposal without accepting the terms of the contract outright. The report can also note the number of contracts that were distributed through the contract exchange yet were neither accepted nor negotiated using the product's functionality.

During the negotiation process if the original contract template was created by compiling a series of individual clauses and was subsequently negotiated on a clause-by-clause level the creator user would be able to access the users associated clause library and select alternate clauses that could be used to replace the initial standard contractual language. Consistent with the notion of defining various levels of privileges, the extent to which this access to an ability to use alternate clauses could be limited to specific users on behalf of a given party to the negotiation. As a further possibility, the user having a negotiator role may be able to edit contractual language directly or to delete clauses from a contract entirely or add new clauses. As is suggested above, the additional or deletion of particular clauses may require the approval of one or more other users associated with the party. This approval requirement can be transmitted to or shown to the requisite users by way of the workbench associated with that given user as described above.

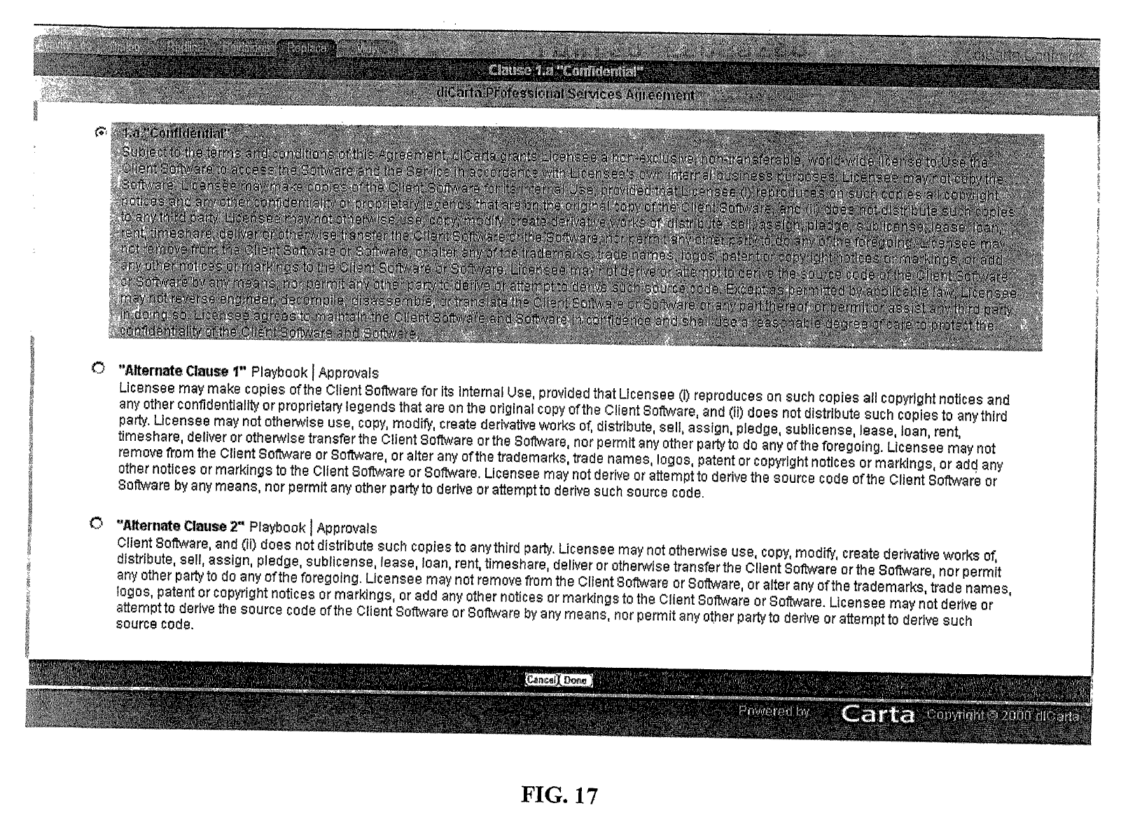

FIG. 17 illustrates a user interface which provides an alternative language or alternative clause which could be utilized depending on a given scenario within a contract. For instance, the original language may relate to confidentiality requirements with regard to certain exchanged information. The figure illustrates alternative confidentiality clauses that may be appropriate under various circumstances. FIG. 17 illustrates the ease with which this information is presented for selection to a user.

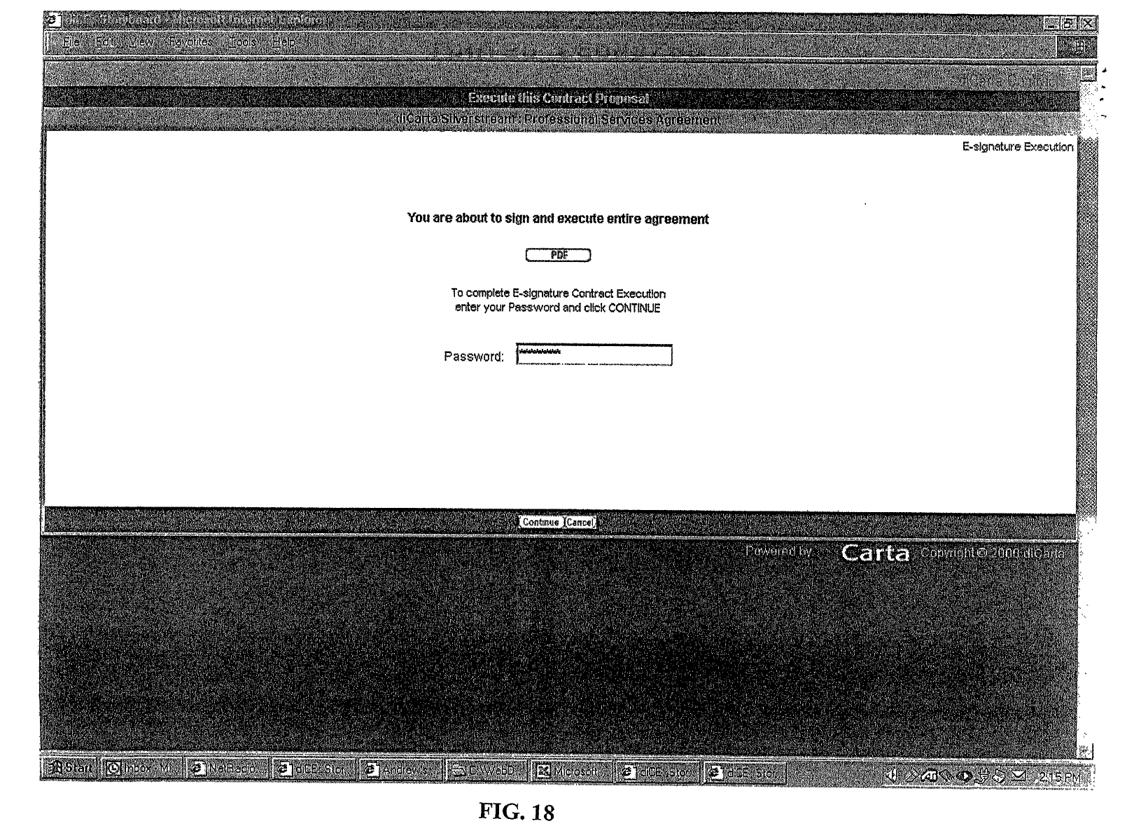

Upon both parties approval of all contractual clauses the users having an executor role will have the ability to electronically sign the contract proposals, thereby allowing the entire contract distribution and acceptance cycle to take place on-line. FIG. 18 provides a screenshot of the interface which might be provided to the user to enable electronic signature of the document. Naturally there may be potential hesitation about digital signatures on behalf of one or both of the parties. Thus both parties will also have the ability to print the contract proposal sign it and send it to the other party. All contracts that are executed through the contract exchange should be available for viewing to all parties involved. For example a central URL could be provided representative of the location on the exchange where the document could be accessed on a 24 hour a day 7-day a week basis. Electronically signed contracts can be automatically stored in a contract exchange. Furthermore, the creator of a document will have the ability to scan hard copy executed documents and load such a scanned document into the contract master portion of the contract exchange. Upon entry into the contract master both parties should be provided a hyperlink to a web page at which both parties can have access to the cosigned contract.

Member company users will have the ability to run a series of reports to track risk, revenue, outstanding obligations, word usage and execution of nonstandard clauses. To the extent that the report provides information about obligations this will allow a subscriber to better manage those current obligations and avoid potential noncompliance issues. Obligations can be cross-referenced with clause related revenue to gauge the amount of revenue attached to outstanding obligations. Risk management reports will aid a subscriber in evaluating the number of high-risk clauses agreed upon and outstanding revenue attached to those high-risk clauses. To the extent that the system tracks the modification of clauses it is possible also to generate reports about modified clauses to inform subscribers about language that is frequently negotiated and to allow them to refine that language to expedite future negotiations. The member companies are also provided with a repository of contracts with access on the 24 hour a day 7 day a week basis to view all of the executed contracts that have been constructed utilizing the contract exchange.

The method and system of the present invention provides techniques by which multiple parties have access to and can negotiate the content of a document. The operation facilitates the creation of a proposed document and then monitors and governs the procedures by which the proposed document can be modified by the respective parties who access the document through an exchange. The present invention provides selectable privileges to be assigned to various users of the system where the users are representatives or agents of given parties to the transaction. The invention also provides a depository for executed documents as well as a compilation of a comments or revision history that is associated with an executed document which can be used for reconstruction the negotiation process if necessary to interpret the language ultimately agreed upon in the executed document.

What is claimed is:

1. A method for facilitating negotiation of document content, the method comprising:
creating a database of document template content;
receiving commands from a first party to create a document for negotiating;
selecting content from said database based on receipt of said commands;
associating said selected content with a first document;
notifying a second party as to the existence of said first document;
receiving proposed edits to said first document based on information from said second party;
creating a revision history based on said proposed edits;
associating said revision history with said document;
receiving proposed further edits based on information from said first party; and
supplementing said revision history based on said proposed further edits.

2. A method for facilitating negotiation of a contract, the method comprising:
creating a system database including a plurality of standard contract clauses;
receiving a command from a first user to construct a user-specific database;
in response to receiving a command, selecting one of said plurality of standard clauses from said system database; and
associating said selected one of said plurality of standard clauses with said userspecific database.

3. The method of claim 2 further comprising:
receiving a command to select a contract template using said user-specific database;
creating a proposed contract using the selected contract template; and
notifying a second party of the existence of said proposed contract.

4. The method of claim 3 farther comprising:
creating a negotiation history file associated with said proposed contract;
receiving proposed edits to said proposed contract based on information from said second party;
creating a revision history based on said proposed edits; and
storing said revision history in said negotiation history file.

5. A method for operating a contracts exchange, the method comprising:
creating a standard clause database associated with the exchange;
registering a plurality of users;
creating a member database for each of said plurality of registered members;
for a first one of said plurality of registered members associating with the corresponding member database a first set of standard clauses from said standard clause database; and
for a second one of said plurality of registered members, associating with the corresponding member database a second set of standard clauses from said standard clause database;
wherein said first and said second set of standard clauses differ from one another.

6. A method for creating a contracts exchange, the method comprising:
registering a first user;
receiving, in electronic form, a first contract from said first user;
identifying a plurality of clauses in said first contract;
creating a clause database associated with said first user using the identified plurality of clauses;
registering a second user;
receiving in electronic form, a contract from said second user;
identifying a plurality of clauses in said contract from said second user; and
creating a user clause database associated with said second user using the identified plurality of clauses in said contract from said second user.

7. A method for securely maintaining contract negotiation history, the method comprising: permitting a first party and a second party access to a computer-based contract negotiation tool;
assembling a draft contract in accordance with commands from the first party;
presenting said draft to said second party;
inserting proposed revisions into said draft in accordance with commands from said second party;
automatically creating a contract negotiation history using information related to said proposed draft and said proposed revisions; and
storing said contract negotiation history.

8. The method of claim 7 wherein said step of storing comprises protecting the stored contract negotiation history from being edited.

9. The method of claim 7 wherein said step of storing comprises preventing revision of stored contract negotiation history while permitting addenda to said stored contract negotiation history.

10. A method for controlling an on-line negotiation process, the method comprising;
registering a first party and a second party for a negotiation regarding a contract wherein each party comprises a plurality of users;
defining negotiation privileges for each of the users of said first party;
defining negotiation privileges for each of the users of said second party;
creating a proposed contract;
storing the contract at a contract exchange; and
permitting a level of access to said contract for a user commensurate with negotiation privileges defined for said user.
